(19) United States
(12) Patent Application Publication
(10) Pub. No.: US 2022/0010952 A1
(43) Pub. Date: Jan. 13, 2022

(54) HEAT-DISSIPATION DEVICE OF LED

(71) Applicant: Yixing ZHANG, Beijing (CN)

(72) Inventor: Yixing ZHANG, Beijing (CN)

(21) Appl. No.: 17/484,559

(22) Filed: Sep. 24, 2021

Related U.S. Application Data
(63) Continuation-in-part of application No. 15/320,837, filed on Dec. 21, 2016.

(30) Foreign Application Priority Data
Jul. 4, 2014 (CN) 201410317415.1

(51) Int. Cl. F21V 29/80; F21V 29/503; F21V 29/60

(52) U.S. Cl. CPC F21V 29/80; F21Y 2115/10; F21V 29/60; F21V 29/503

(57) ABSTRACT

A heat-dissipation device for LEDs includes a plurality of heat conducting material wires. The heat-dissipation housing of an LED chip is in contact with one end of the heat conducting material wires through a heat conducting material or in a direct manner so that heat is transferred from the housing to the wires and further to the surrounding air. The heat conducting material wires are arranged in an air flowing pipeline and the heat is taken away by the flowing air. The pipeline is made of insulation materials.

### CROSS-REFERENCE TO RELATED APPLICATION

This application is a continuation in part of U.S. application Ser. No. 15/320,837, filed Dec. 21, 2016, which is a U.S. national stage entry of PCT international application no. PCT/CN2015/083294, filed Jul. 3, 2015, which claims the benefit of the priority of Chinese patent application no. 201410317415.1, filed Jul. 4, 2014, the contents of which are incorporated herein by reference in their entirety.

### FIELD OF TECHNOLOGY

The present invention belongs to the field of lighting electrical appliance, and specifically relates to a heat-dissipation device of an LED (Light Emitting Diode).

### BACKGROUND

LED heat dissipation is usually to dissipate heat into the air. The LED transmits heat to a surface of the heat conducting material contacted with the air through the heat conducting material of the heat-dissipation device, heats the air through the surface, and takes away the heat by the flowing air. Apparently, this heat-dissipation surface plays a vital role. A sufficiently large heat-dissipation surface is an indispensable and necessary condition to ensure that the heat-dissipation device can dissipate heat normally.

There are many ways to increase the heat-dissipation surface. Increasing a size of the heat-dissipation device, or making the heat-dissipation device have a complex shape (for example, using a large number of plate-shaped or pin-shaped heat-dissipation fins), can increase an area of the heat-dissipation surface, which are methods that have been widely adopted. Also, there are a plurality of patented technologies, and an original intention of technical solutions thereof is to increase the area of the heat-dissipation surface. However, why heat dissipation of a high-power LED is still an unsolvable problem so far?

To transmit heat requires a temperature difference: to dissipate heat into the air requires a temperature difference, and heat which is inside a radiator also requires a temperature difference to conduct on the heat conducting material. As a matter of fact, even if a heat conducting material with good heat-conducting property is not easy to conduct heat. For a high-power LED radiator, temperature rise caused by heat conduction inside the radiator is actually a main part of the temperature rise of the LED device.

Aluminum has better heat-conducting property in heat conducting materials. As shown in FIG. 1, for an aluminum alloy with a coefficient of heat conductivity of 160 (W/m·K), a temperature difference of 10° C. is required to transmit 1.6 watts of heat to 1 cm on an aluminum alloy plate with a thickness of 1 mm and a width of 1 cm. As for a steel plate (a coefficient of heat conductivity of 50 W/m·K), the required temperature difference will be 32° C.

It refers to only 1.6 watts herein. Most of the electric energy (about ⅔) consumed by the high-power LED is used for heating. For an LED lamp of tens of watts to hundreds of watts, the heat transmitted by heat dissipation reaches tens of watts, or even hundreds of watts, and the temperature rise produced in a conduction process will be very large. An allowable temperature rise limit of the heat-dissipation surface of the LED chip is only a few tens of degrees Celsius (for example, 30° C.), which is too easy to exceed.

Although increasing the size of the radiator and adopting various fin structures can increase the area of the heat-dissipation surface, since a distance between a heat emitting element and the heat-dissipation surface is increased at the same time, there is little effect, and often counterproductive. Moreover, because the problem lies in the process of heat conduction on the heat conducting material inside the radiator, forced ventilation is useless because wind cannot blow into the heat conducting material of the radiator. Therefore, the heat-dissipation problem of the high-power LED has not been resolved yet.

The technical solution of the US patent Bartilson (U.S. Pat. No. 5,083,194A, filing date: Jan. 21, 1992) is to generate a large piece of needle-shaped objects (namely, needle-shaped fins) each with a rectangular column structure on a heat-dissipation plane to increase the heat-dissipation surface.

First, a large piece of rectangular columns is used to increase the heat-dissipation surface, and an increased surface area depends on lengths, widths, and heights of the rectangular columns and gaps between the rectangular columns. It is assumed that the height of the rectangular column is h, and the length, the width, and the gap are all d, and compared with an occasion when there is no rectangular column in a heat-dissipation plane, an extra area will be h/d times of an original heat-dissipation plane, which all depends on a height-diameter ratio of the rectangular column.

If the rectangular column is replaced by a cylinder with a diameter of d, all else being the same, an increased area of the heat-dissipation surface will be (πh/4d) times that of the original heat-dissipation surface, which is still proportional to the height-diameter ratio h/d, but a little bit less. If these cylinders are gathered together, tightly packed together, ideally the increased area of the heat-dissipation surface may be (3.628 h/d) times that of the original heat-dissipation surface. Therefore, for the heat-dissipation device using the needle-shaped fins, increase of the heat-dissipation surface depends on height-diameter ratios of the needle-shaped fins. Specifically, for the US patent Bartilson (U.S. Pat. No. 5,083,194A), namely, h=0.080 inches, d=0.012 inches, compared with the occasion when there is no rectangular column in the plane, the extra area will be h/d times of an original generating plane, namely, 0.080/0.012=6.66 times more area. Although the extra 6.66 times of area of the heat-dissipation surface has achieved a certain heat-dissipation effect, there is still a long way to resolve the heat-dissipation problem of the high-power LED.

Apparently, whether to reduce d or increase h, a value of the height-diameter ratio h/d can be increased, thereby increasing the heat-dissipation surface. Reducing d is apparently the best choice herein. However, when d is small, such as less than 0.3 mm (about 0.012 inches), the value of h cannot be too large, because even if not subjected to external force, a columnar body will bend under internal stress and cannot form the columnar body on the heat-dissipation plane by casting or cutting. The U.S. patent Bartilson (U.S. Pat. No. 5,083,194A) h/d=6.66 is already the maximum limit.

This situation has been radically changed by adopting heat conducting material wires as thin as possible that are produced by a drawing process.

### SUMMARY

To achieve the foregoing purposes, the present invention provides a heat-dissipation device of an LED.

According to the technical solution of the present invention, the heat-dissipation device of the LED includes a large number of heat conducting material wires made of a heat conducting material, the diameters of the heat conducting material wires are greater than 0.01 mm and less than 0.3 mm, and the lengths of the heat conducting material wires are such that the ratios of length to diameter of the heat conducting material wires are greater than 20, a heat-dissipation housing of an LED chip is contacted with one end of the heat conducting material wires made of the heat conducting material through the heat conducting material or in a direct manner, in order to heat air around the heat conducting material wires, and the heat is taken away by the flowing air, and where

one end of the heat conducting material wires is integrated with the heat-dissipation housing of the LED chip by welding, casting or thermally conductive adhesive bonding.

Further, the lengths of the heat conducting material wires are such that the ratios of length to diameter of the heat conducting material wires are greater than 30.

Further, the lengths of the heat conducting material wires are such that the ratios of length to diameter of the heat conducting material wires are greater than 50.

Further, the lengths of the heat conducting material wires are such that the ratios of length to diameter of the heat conducting material wires are greater than 100.

Further, the heat conducting material is copper; and the heat conducting material wires are copper wires.

Further, surfaces of the heat conducting material wires are covered by a protective layer for preventing the heat conducting material wires from being oxidized, corroded or polluted.

Further, the protective layer covering the surfaces is a silver plating.

Further, the heat conducting material wires are arranged in an air-flowing pipeline; a blower is connected into the pipeline, and air is circulated by means of the blower to take away heat.

Further, the heat conducting material wires are arranged in an air-flowing pipeline; an outlet and an inlet of the pipeline have a certain height difference, air becomes light by means of heating expansion to form a pressure difference between the outlet and the inlet, and air circulation is accelerated to take away heat.

Further, the pipeline is made of an insulation material, in order to ensure ground insulation of the entire heat-dissipation device.

Herein, “the diameters of the heat conducting material wires are greater than 0.01 mm and less than 0.3 mm”, but actually, lengths of the heat conducting material wires can be cut arbitrarily according to actual needs. Copper wires and iron wires sold on the market as the heat conducting material wires are packaged in reels according to relevant standards, and a length of each reel reaches several hundred meters. The heat conducting material wires may be intercepted at will according to actual needs during use almost with no limit. For example, if the diameter is an intermediate value of 0.1 mm, and the length is 1 cm, the height (length)-diameter (width) ratio h/d=100 can be easily obtained. If a cable diameter is 0.02 mm, the height-diameter ratio h/d=500. If the lengths of the heat conducting material wires are further increased, the height-diameter ratio h/d can be further increased almost with no limit. This is several orders of magnitude different from the h/d=6.66 of the US patent Bartilson (U.S. Pat. No. 5,083,194A), which is too much. Compared with the US patent application Lee (US 2012/0234519), on the one hand, the technical solution of the present invention does not have a stipulation that “the length is not greater than about 3 mm”, on the other hand, this is obviously not an order of magnitude with a stipulation that “the needle-shaped fin has a height-diameter ratio not less than about 10”.

In this way, the technical solution of the present invention can easily increase the area of the heat-dissipation surface by more than hundreds of times. This makes it possible to obtain sufficient heat-dissipation surface required for heat dissipation with very short heat conducting material wires. Herein, the very short heat conducting material wires refer to that heat can reach the heat-dissipation surface by conducting a small distance along the heat conducting material wires. For example, the foregoing heat conducting material wires are only 10 mm long, and the heat generated by the LED chip is conducted to side surfaces of the heat conducting material wires with a conducting distance less than 10 mm.

Diameters greater than 0.01 mm and less than 0.3 mm are the minimum diameters of copper wires and iron wires as the heat conducting material wires specified by relevant standards. Using as thin heat conducting material wires as possible allows the heat generated by the LED chip during operating to be transmitted over a small distance to a heat-dissipation surface large enough for heat dissipation. This first means that a main part of the temperature rise of the high-power LED—the temperature rise of the heat transmitted inside the heat-dissipation device—will be greatly reduced and the temperature rise will be mainly used to heat the air contacted with the heat conducting material wires, and dissipate the heat through convection.

At the same time, very short heat conducting material wires also means that a volume and mass of the entire heat-dissipation device will be greatly reduced.

As stipulated in the technical solution of the present invention: “one end of the heat conducting material wires is integrated with the heat-dissipation housing of the LED chip by welding, casting or thermally conductive adhesive bonding”, this is another main technical feature of claim 1.

The coefficient of heat conductivity of the air (2.59·10⁻² (W/m·K)) is very small, which is almost only one ten thousandth of that of a heat conducting material of aluminum (a coefficient of heat conductivity is 236 (W/m·K)). This makes the temperature rise generated by the heat passing through a 1 micron air-gap equivalent to passing through a 10 mm aluminum rod, so even a small air-gap has considerable heat resistance, and a considerable temperature rise will be generated when the heat is conducted, which may affect a heat dissipation effect.

When cable diameters of the heat conducting material wires are very small (less than 0.3 mm), it is actually impossible to make an end face of each of a large number of heat conducting material wires closely contacted with the heat-dissipation surface of the LED chip without leaving a little gap. At this time, the heat generated by the LED chip during operating cannot be well transmitted to the heat conducting material wires, to further heat air through the surface of the heat conducting material wires and perform convection for heat dissipation. To enable one end of the heat conducting material wires to be integrated with the heat-dissipation housing of the LED chip by welding casting or thermally conductive adhesive bonding will be an effective way to eliminate the temperature rise.

### BRIEF DESCRIPTION OF THE DRAWINGS

FIG. 1 is a schematic diagram of one end of heat conducting material wires being integrated with a heat-dissipation housing of an LED chip according to an embodiment of the present invention; and

FIG. 2 is a schematic diagram of heat conducting material wires being arranged in an air-flowing pipeline according to an embodiment of the present invention.

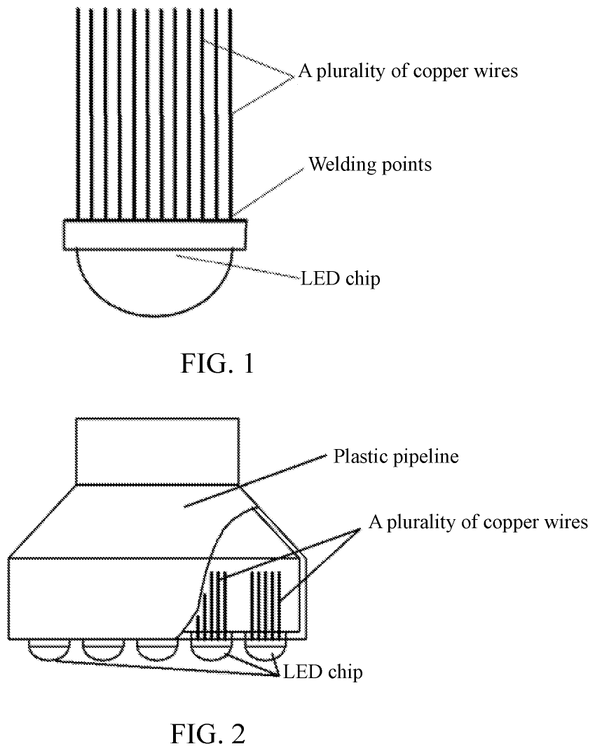

### DESCRIPTION OF THE EMBODIMENTS

In specific implementations, in order to obtain the best heat dissipation effect, the heat conducting material wires are always selected as thin as possible when the situation permits. However, very thin heat conducting material wires may bring a lot of inconvenience to processing, and too long heat conducting material wires may make the structure complex and cause trouble. Therefore, selection of both the cable diameters and the lengths of the heat conducting material wires needs to be based on a power of a specific heating element, an operating environment, and other specific conditions to meet a required height-diameter ratio h/d (height/diameter) for heat dissipation.

### Embodiment 1. A 1 W LED Lamp Bead

Taking an AWG (American wire gauge) No. 30 copper wire (a cable diameter of 0.255 mm), cutting a large number of copper wires with each length of 20 mm, and sticking these copper wires together with a 6 mm wide soldering tin. Fixing a heat-dissipation surface of an LED lamp bead with a current of 350 MA and a voltage of 3.2-3.4V on the soldering tin in the middle of these copper wires with the thermally conductive adhesive. Connecting a DC power supply correctly and inputting a current of 350 MA. The LED chip operates normally and emits light.

After the LED chip operates and emits light for 1 hour, a thermocouple probe is used to measure the temperature rise on the heat-dissipation surface of the LED chip. After repeated measurements, the temperature rise is always less than 30° C.

At this time, a length of the heat-dissipation copper wire is 7 mm with a height-diameter ratio of h/d=7/0.255=27.

### Embodiment 2. A 30 W LED Lamp

The heat conducting material wires are copper wires of copper braids usually used by electricians. A diameter of the copper wire is 0.12 mm, and a braid width is about 30 mm.

Take 3 sections of the copper braid, and each section is 150 mm in length. Stretching the braid to form a cylinder, and cutting the cylinder to obtain 3 groups of interwoven copper wires, which is forming 3 planes with a length of 150 mm and a width of 60 mm.

The LED chip adopts LED lamp beads with a current of 350 MA and a voltage of 3.2-3.4V per piece. Fixing heat-dissipation surfaces of 30 lamp beads on the copper wires of the foregoing 3 sections of braids with the soldering tin and the thermally conductive adhesive, and ensuring that the heat-dissipation surfaces of the lamp beads and the copper wires of the braids can conduct heat well. Enabling the copper wires of the 3 sections of copper braid to be overhead to ensure that air circulation around the copper wires is not affected.

Herein, a width of the soldering tin in the middle of the braid is 6 mm, lengths of the heat-dissipation copper wires on both sides are 27 mm, and cable diameters of the copper wires are 0.12 mm with a height-diameter ratio of h/d=27/0.12=225.

The LED chip is connected correctly to drive the power supply with 30 W constant power output to supply power to the LED chip. After the LED chip operates and emits light for 1 hour, a thermocouple probe is used to measure the temperature rise on the heat-dissipation surface of the LED chip. After repeated measurements, the temperature rise is always less than 25° C.

What is mentioned above is the description of the embodiments of the present invention. However, the present invention is not limited to the foregoing description of the embodiments. The foregoing description of the embodiments is only illustrative but not restrictive. Under the enlightenment of the present invention, those of ordinary skills in the art can make many forms without departing from the purpose of the present invention and the protection scope of the claims, and these all fall within the protection of the present invention.

1. A heat-dissipation device of an LED, wherein the device comprises a large number of heat conducting material wires made of a heat conducting material, the diameters of the heat conducting material wires are greater than 0.01 mm and less than 0.3 mm, and the ratios of length to diameter of the heat conducting material wires are greater than 20, a heat-dissipation housing of an LED chip is contacted with one end of the heat conducting material wires made of the heat conducting material through the heat conducting material or in a direct manner, in order to heat air around the heat conducting material wires, and the heat is taken away by the flowing air,
wherein, one end of the heat conducting material wires is integrated with the heat-dissipation housing of the LED chip by welding, casting or thermally conductive adhesive bonding.

2. The heat-dissipation device of the LED of claim 1, wherein the ratios of length to diameter of the heat conducting material wires are greater than 30.

3. The heat-dissipation device of the LED of claim 1, wherein the ratios of length to diameter of the heat conducting material wires are greater than 50.

4. The heat-dissipation device of the LED of claim 1, wherein the ratios of length to diameter of the heat conducting material wires are greater than 100.

5. The heat-dissipation device of the LED of claim 1, wherein the heat conducting material is copper; and the heat conducting material wires are copper wires.

6. The heat-dissipation device of the LED of claim 1, wherein surfaces of the heat conducting material wires are covered by a protective layer for preventing the heat conducting material wires from being oxidized, corroded or polluted.

7. The heat-dissipation device of the LED of claim 6, wherein the protective layer covering the surfaces is a silver plating.

8. The heat-dissipation device of the LED of claim 1, wherein the heat conducting material wires are arranged in an air-flowing pipeline; a blower is connected into the pipeline, and air is circulated by means of the blower to take away heat.

9. The heat-dissipation device of the LED of claim 1, wherein the heat conducting material wires are arranged in an air-flowing pipeline; an outlet and an inlet of the pipeline have a certain height difference, air becomes light by means of heating expansion to form a pressure difference between the outlet and the inlet, and air circulation is accelerated to take away heat.

10. The heat-dissipation device of the LED of claim 8, wherein the pipeline is made of an insulation material, in order to ensure ground insulation of the entire heat-dissipation device.

11. The heat-dissipation device of the LED of claim 9, wherein the pipeline is made of an insulation material, in order to ensure ground insulation of the entire heat-dissipation device.
